(19) United States
(12) Patent Application Publication
(10) Pub. No.: US 2004/0069420 A1
(43) Pub. Date: Apr. 15, 2004

(54) Guardian personnel protection system-quantum series

(76) Inventor: James Petriello, Valley Cottage, NY (US)

Correspondence Address: JAMES T. PETRIELLO, 299 CHRISTIAN HERALD RD, VALLEY COTTAGE, NY, 10989, US

(21) Appl. No.: 10/270,903

(22) Filed: Oct. 15, 2002

(51) Int. Cl. E05D 15/26

(52) U.S. Cl. 160/199

(57) ABSTRACT

Electrically operated folding operable walls controlled by an electrical operation circuit of the type having a key switch, a control panel, an extend limit, a stack limit, control relays and a motor. The invention consists of a mechanism designed to provide safety during the operation of said folding walls by sensing a person with dual stage detector that will sense a person directly in the operable folding wall's path, floor mat sensors to detect the presence of a person in the stack area, and a control unit wired to the folding wall control panel, will shut down the operation of the folding wall. Another mechanism provides for the restarting of the folding wall by resetting the relay inside the control panel.

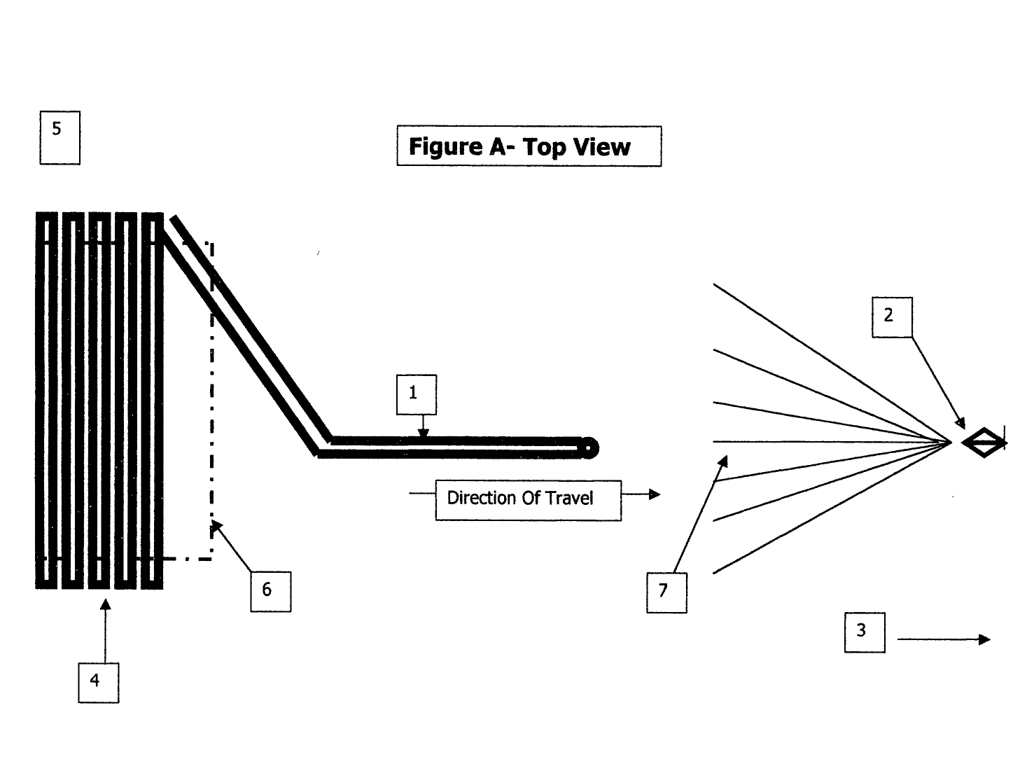

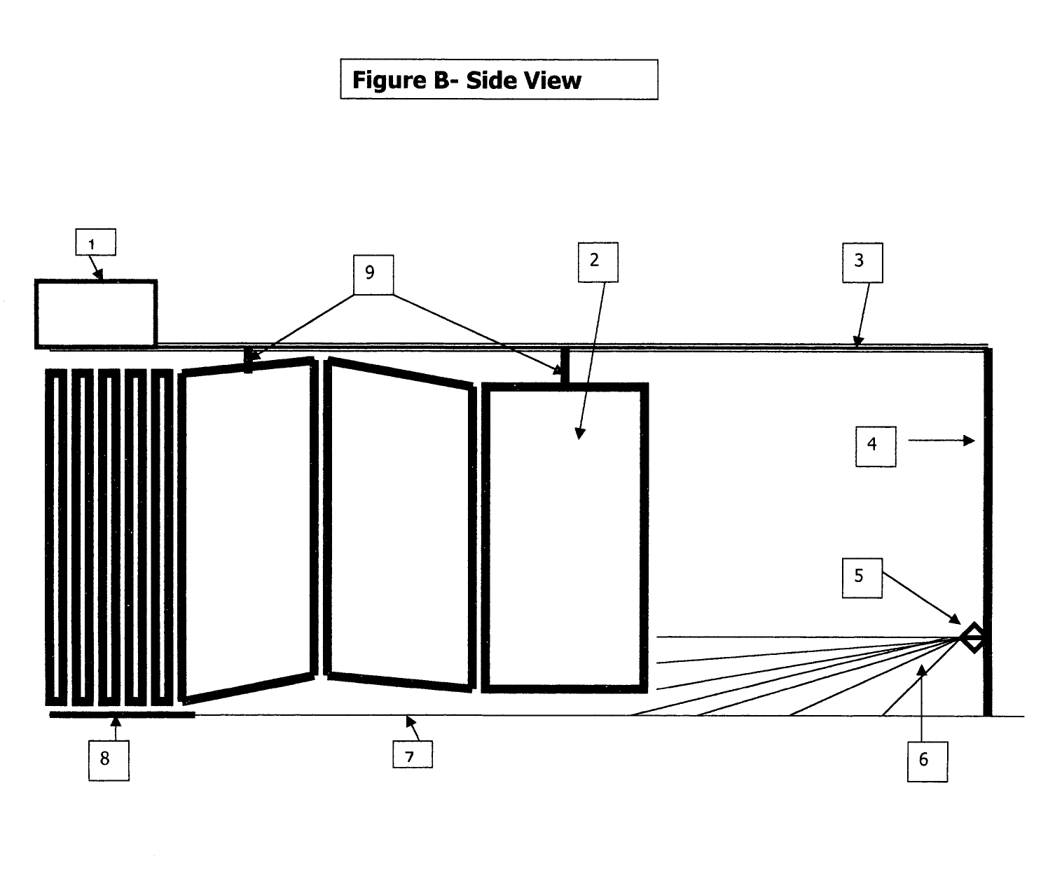

### CROSS-REFERENCE TO RELATED APPLICATIONS

| | | | |
|---|---|---|---|
| 2909718 | October, 1959 | Lawick | 49/25. |
| 2987121 | June, 1961 | Haws | 160/188. |
| 3446264 | May, 1969 | Roemer | 160/188. |
| 3852592 | December, 1974 | Scoville et al. | 340/555. |
| 4447726 | May, 1984 | Mudge et al. | 340/567. |
| 4707604 | November, 1987 | Guscott | 340/567. |
| 4719363 | January, 1983 | Gallacher | 340/555. |
| 4894952 | January, 1990 | Trett et al. | 49/25. |
| 4939359 | July, 1990 | Freeman | 340/567. |
| 5107120 | April, 1992 | Tom | 340/567. |
| 5152332 | October, 1992 | Siener | 160/188. |
| 5703368 | December 1997 | Tomooka | 250/349 |
| 6054658 | April, 2000 | Duhon, et al. | 200/86R |

### FEDERALLY SPONSORED REASEARCH & DEVELOPMENT

“Not applicable”

### SEQUENCE LISTING

“Not applicable”

### BACKGROUND OF THE INVENTION

Field of the invention: the invention relates generally to electrically operated folding walls and more specifically to electrically operated gymnasium partitions.

### SUMMARY OF THE INVENTION

A first object of the invention is to enable electrically operated folding walls to overcome the obvious safety shortcomings of prior devices.

A second object is to provide electrically operated folding walls that will include a safety device that will respond to detection of with a person or object and immediately shut down the electrical control circuit, disabling the operable folding wall.

A third object is to provide said safety device without the need for cumbersome and often unreliable wiring, which must bend one hundred and eighty degrees each time the folding wall is operated due to the fact that it must be physically attached to the top of the folding wall.

A fourth object is to provide an operable folding wall that is safe to operate at any given time.

A fifth object is to provide a safety system that is reliable, simple and easy to operate.

A sixth object is to provide a safety system that is on and armed as long as the folding wall electrical supply circuit is energized.

### BRIEF DESCRIPTION OF THE VIEWS OF THE DRAWINGS

Figure A is a top view of a typical electric folding wall.

Item 1 is the lead panel of the folding wall.

Item 2 is the sequentially conformed multi-stabilized motion detector.

Item 3 is the far wall or termination point.

Item 4 is the stacked folding wall.

Item 5 is the receiver unit from the invention that will interrupt the common wire of the folding wall's control circuit.

Item 6 are the floor mat(s) placed under the folding wall in the stack area.

Item 7 are the motion detector's sensing beams.

Figure B is a side view of a typical electric folding wall.

Item 1 is the motor drive assembly.

Item 2 is the lead panel.

Item 3 is the partition suspension track.

Item 4 is the far wall or termination point.

Item 5 is the sequentially confirmed multi-stabilized motion detector.

Item 6 is the sensing beams of the detector.

Item 7 is the gymnasium or building floor.

Item 8 are the sensing mat(s) positioned under the folding wall.

Item 9 are partition suspension bolts.

### DETAILED DESCRIPTION OF THE INVENTION

Electrically operated folding walls are inherently dangerous simply because of the large amount of force needed to move their immense weight. If pinned by a folding wall, a person can be severely injured or killed by its crushing force. Using the figure “A” as a guide, the description is as follows: The sequentially confirmed multi stabilized motion detector (2) mounted at the termination point (3) of the partition will detect a person passing in front of said partition. When this sensor detects a person in front of the partition, the switch inside closes, completing a circuit inside the detection unit which then sends a signal via hard wires to the electrical control box (5), which in turn opens the common circuit of the electrical control circuit, which immediately halts the operation of the folding wall by shutting off power the drive motor assembly (1 of Fig. B). The advantage of having a sequentially confirmed multi-stabilized (2) detector is that it is capable of detecting a human target, but will not detect the movement of the partition, allowing the detector to be mounted directly in front of the partition, that is to say, in it's path.

Furthermore, the floor mats (6) operate in a manner that will halt the motion of the folding wall when pressure is applied to them. That is to say, while the folding wall is traveling in a reverse direction, a person may attempt to travel behind it to get to the opposite side of the room. In their attempt to do so, they would be required to step on the floor mat (6). The force of the weight of the person would then close the switch inside the mat and complete a circuit inside the electrical control box (5), which would open the common circuit of the electrical control circuit and halt the operation of the folding wall as described above.

Once the operation has been halted, the operator may reset the safety device by pushing a reset button (not shown) allowing the power to be restored to the drive motor assembly (1 of Fig. B).

While certain features of this invention have been shown and described and are pointed out in the claims, it is not intended to be limited to the details above, since it will be understood that various omissions, modifications, substitutions, and changes in the forms and details of the device illustrated and in its operation can be made by those skilled in the art without changing in any way the spirit of the invention.

What I claim is new and desired to be protected by patent is set forth in the appended claims:

1. Electrically operated folding operable walls controlled by an electrical operation circuit of the type having a key switch, a control panel, an extend limit switch, a stack limit switch, control relays and a motor, in which the invention being a safety system comprises:
a) Means for providing a wall mounted motion sensor that will detect a person or persons entering the area directly in front of a moving operable partition without detecting the movement of the partition itself;
b) Means for providing one or two floor mats, placed under the partition, in the stack area to allow an object placed on or a person stepping on said mats thereby applying pressure, to activate the internal strip switch while the motorized operable wall is in a reverse motion;
c) Means for shutting down the electrical operation circuit of said folding operable walls when a person or persons enter the area directly in front of the moving partition, or a person
d) steps on, or an object is placed on the floor mats, said shutting down means includes a control unit electrically connected between the control panel of the electrical operation circuit and the motion detector, which will turn off the electrical operation circuit upon detection of a person directly in front of or present in the stack area of the folding operable wall;
e) Means for restarting the electrical operation circuit of said folding operable wall after the person or object has been removed from the path of the folding operable wall; said restarting means includes a reset control switch, either button or key operated, mounted on the wall in proximity to the operable folding wall's original operating switch which, when activated, will reactivate the electrical operation circuit allowing the folding operable wall to be operated again.
